(19) United States
(12) Patent Application Publication
(10) Pub. No.: US 2003/0220801 A1
(43) Pub. Date: Nov. 27, 2003

(54) Audio compression method and apparatus

(76) Inventor: Thomas E. Spurrier, Wheeling, IL (US)

Correspondence Address: Richard C. Litman, LITMAN LAW OFFICES, LTD., P.O. Box 15035, Arlington, VA, 22215, US

(21) Appl. No.: 10/151,815

(22) Filed: May 22, 2002

(51) Int. Cl. G10L 21/04

(52) U.S. Cl. 704/503

(57) ABSTRACT

A method and system for communicating audio signals at a low bit rate and yet retaining significant representation of the original signal is disclosed in this patent This method interweaves both compressed audio and a messaging protocol into a data stream that can be transmitted over any digital communication medium thus eliminating the need for higher levels of protocol overhead. A digitally sampled wave (from a microphone) is accumulated in a memory and subsequently compressed by finding a maximum value (peak) followed by a minimum value (valley) and recording the count of the number of samples between the peak and valley. A digital band pass filter (BPF), such as an IIR or FIR, is used on the input raw wave to smooth and eliminate noise thus increasing compressibility. A protocol consisting of commands and information are interwoven with the compressed signal. This interwoven protocol data is de-commutated prior to regeneration of the signal. The output of the audio compressor and protocol commutator is connected to a transmission channel that provides a circuit path to the receiver. A wave is regenerated by connecting a half wave spline containing a point for each sample between a peak and valley. A cosine function is used to regenerate the spline. The regenerated signal is placed into a memory that subsequently transferred into a digital to analog converter that is connected to an audio sensor (earphone or speaker).

### BACKGROUND OF THE INVENTION

1. Field of the Invention

The present invention relates generally to data compression. More specifically, the invention is a method and system for compressing audio data while retaining the original quality and identity of data during a file transfer protocol (ftp) transmission and/or transmission over the Internet.

2. Description of the Related Art

Numerous data compression techniques have been devised to prepress files for efficient storage management and data transmission over communication lines. Data compression techniques have long been used for speeding up data transfer, by reducing the amount of space taken up by the information being sent. Compression is also useful over split bandwidth transmission links where even though the downlink may be very fast, the uplink may be very slow.

Audio compression methodologies are generally categorized into two broad groups: time domain and frequency domain. The time domain types create a lower continuous bit rate and include such methods as ì-Law, A-Law, ADPCM, ÄM, Phased Encoded, and Linear Predictive Coding. Frequency domain transforms are window based and produce packets of parameters from algorithms such as Discrete Fourier Transforms, Fast Fourier Transforms, Multi-Bandpass Frequency Filtering, and Wavelet Transforms.

While the audio compression method and apparatus of the instant invention falls under the time domain group, it produces a variable bit rate transmission stream interwoven with ASCII messages generally best inserted when the bit rate is low. In this regard, there are two generally known categories of data compression namely loss-less and lossy data compression types. Loss-less data compression has the primary advantage of preserving all the information of data, useful for binary, text and image (eg. medical images) files which must be perfectly preserved. Lossy data compression throws away some non-essential information and is typically useful for sound, images and video files. It is customary in conventional compression methods and devices in industry to throw away some information when recording sound, pictures, and video, particularly in analogue tape recording and photography as lossy processes. However, the preservation of all information for certain audio data is absolutely essential in various applications such as voice recognition and simulation devices, at least.

An audio compression method and apparatus which takes audio signals that have been digitally sampled and mapped and transmitted as compressed analog signals over a low bit rate medium such as dial up modems and wireless communications devices as herein described is lacking among conventional devices.

For example, U.S. Pat. No. 4,071,707 issued to Graf and Guanella discloses a process an apparatus for improving the utilization of transmission channels through partitioning audio signals into 20-50 millisecond segments. A low and high band pass filter yields frequency components that are transmitted. The regenerated “resulting signals are at least partly understandable, depending on the appropriate choice of the length of segment”. This method performs a crude 2 band spectrum analysis of segments of an audio signal. The reconstruction incorporates drastic phase shifts which are smoothed out. This process performs domain conversion from time to frequency and back.

U.S. Pat. No. 4,384,169 issued to Mozer and Stauduhar discloses a method for speech synthesizing. Speech is compressed for the purposes of speech synthesizer which can be retrieved and audibly reproduced to recreate the original. Digitized speech is differentiated via delta modulation. Pitch periods are linearly interpolated until all pitch periods contain 96 digitizations and the resulting amplitudes are normalized. The compression method is basically the floating-zero two-bit delta modulation which provides continuous two times compression followed by phoneme selection for subsequent identification. The digital signals are compressed in the computer by subjectively removing preselected relatively low power portions by a process termed “IX period zoning” and by discarding redundant speech information.

U.S. Pat. No. 4,398,059 issued to Lin et al. discloses a speech producing system comprising a microprocessor, an allophone library, stringer and synthesizer. The system receives allophonic codes and produces speech-like sounds corresponding to these codes, through a loud speaker. A micro-controller controls the retrieval from a Read Only Memory (ROM), of digital signals representative of individual allophone parameters. An LPC speech synthesizer receives the digital signals and provides analog signals corresponding thereto to a loud speaker for generating speech-like sounds with stress and intonation.

U.S. Pat. No. 4,599,567 issued to Goupillaud et al. discloses an apparatus and method for generating a representation of an arbitrary signal wherein the signal is represented as a sum of reference signals derived from a standard wavelet defined on a grid in the frequency domain. Four Bandpass filters are used to measure frequency content which also serves as a form of a spectrum analyzer to produce parameterized wavelet logarithm based correlation values. The discrete representation of the energy content of the signal is determined by proper sampling of the content over time and frequency domains called cells or intervals. The regenerated signal is a sum of each or the four band wavelets as recreated from the correlation values. Simply, the magnitude of sine and cosine waves in four frequency bands are measured and then regenerated, and added together to recreate something in the neighborhood of the original signal. This form of compression is quite granular and reconstruction can deviate significantly based on the sampling interval and original audio complexity.

U.S. Pat. No. 4,700,360 issued to Visser discloses a method and apparatus for converting analog input waveforms into digital signals. A Bandpass filtered input signal is differentiated providing a clipping effect with random noise added, resulting in zero crossings which represent the extrema of the original analog input signal that is fed to an integrator to in effect regenerate the signal. The output of the integrator is fed to a delta modulator or a PCM type digitizer. This apparatus manages wide amplitude dynamic range and bandwidth problems by converting the input signal to a sequence of differentiated zero crossings, then recreating a transformed signal with a constant slope that can be easily compressed using delta modulation and other common forms of compression. While this method conditions the analog signal by detecting clipped differentiated zero crossings, the amplitude is clipped as being insignificant. A second signal digitally identifying zero crossings is fed into an integrator which is output to a normal compression method. While this method identifies extrema, it effectively uses extrema to condition the signal or reform the signal at a lower bandwidth, and then it employs normal compression methods. Since extrema usage make a wave simpler to compress, it still compresses a reconstructed transform of the original wave using conventional compression methods with lossed data.

U.S. Pat. No. 4,817,14 issued to Taguchi discloses a communication system which extracts parameters from a speech signal and converts the respective data into a line spectrum. That is, 10 millisecond audio frames are converted to the frequency domain and coefficients are reconstructed by using the spectrum data to generate tones that are added to regenerate a signal. The converted line spectrum data are multiplexed for serial transmission.

U.S. Pat. No. 5,014,318 issued to Schott et al. discloses an apparatus for checking audio signal processing systems. The method of checking audio signal processing systems uses Fourier analysis contrary to the audio compression method as herein described. In a similar fashion, U.S. Patents issued to Kutaragi et al. (U.S. Pat. No. 5,086,475) and Fielder et al. (U.S. Pat. No. 5,109,417), Kapust et al. (U.S. Pat. No. 5,583,784), Herre et al. (U.S. Pat. No. 5,703,999) and Kitabatake (U.S. Pat. No. 5,890,112) disclose an apparatus which utilizes a Fourier transform method to manipulate sound data.

U.S. Pat. No. 5,020,104 issued to Ciulin discloses a method of reducing the useful bandwidth of bandwidth-limited signals. A filtered signal is passed through a voltage to frequency converter (sort of an instantaneous spectrum analyzer or phase generator commonly used in voltage controlled oscillators and phase lock loops) to form a frequency demodulated signal that is encoded. A decoding of this coded signal involves a frequency to voltage converter.

U.S. Pat. No. 5,243,686 issued to Tokuda et al. discloses a multi-stage linear predictive analysis method for extracting data from acoustic signals. Features are extracted from a sample input by performing first linear predictive analyses of different first orders p on the sampled input signal and second linear predictive analyses on a second order q on the residuals of the first analyses. An optimum first order is selected using information entropy values representing the information content of the residuals of the second linear predictive analyses with one or more optimum second orders selected on the basis of changes in these entropy values. The area of application of this extraction method ranges from speech recognition to the diagnosis of malfunctioning motors.

U.S. Pat. No. 5,459,813 issued to Klayman discloses a human voice public address system with frequency distribution of various voice formats. Selective enhancement of the formats are performed via a spectral analyzer which provides more understandable speech patterns with background noise.

U.S. Pat. No. 5,477,272 issued to Zhang et al. discloses a variable-block size multi-resolution motion estimation scheme which involves the utilization of video compression algorithm scheme. The motion estimation scheme can be used to estimate motion vectors in sub-band coding, wavelet coding and other pyramid coding systems for video compression. Similar wavelet coding is disclosed in the U.S. Patent issued to Gulli (U.S. Pat. No. 5,826,232). The voice synthesis is carried out on the basis of coefficients which are stored and selected during the analysis, preferably using Daubechies wavelets.

U.S. Pat. No. 5,509,017 issued to Brandenburg et al. discloses a signal processing method for transmitting a plurality of signals over a corresponding number of channels. The plurality of individual signals are divided into blocks and the blocks are transformed into spectral coefficients by transformation or filtering. This is simply a time division multiplexor of multiple signals by converting them into the frequency domain.

U.S. Pat. No. 5,533,012 issued to Fukasawa et al. discloses a signal transmission system comprising an audio and channel encoder which transmits a multiplexed signal to a radio transceiver. This is a CDMA access methodology that incorporates ADPCM for multiple access RF mobile stations being access from a base station. The two part spreading coding technique is specific to its technique of using two mutually orthogonal carriers for each part.

U.S. Pat. No. 5,673,210 issued to Etter discloses a signal restoration method which reconstructs a missing portion of a signal from a first known portion of the signal preceding the missing portion via a first and second autoregressive model. A sampled input or speech signal is converted from an analog signal to a digital signal with interpolation techniques involving iterative least square predictor analyses.

U.S. Pat. No. 5,848,391 issued to Bosi et al. discloses a method of encoding time-discrete audio signals. The method includes the step of weighting the time-discrete audio signal via window functions which overlap each other so as to form blocks. In essence, this is a window function system which produces coefficients based on signal variation and not signal matching.

U.S. Pat. No. 5,867,819 issued to Fukuchi et al. discloses an audio decoder which reduces a memory circuit capacity for performing a series of decoding processes. The audio decoder decodes audio data of a plurality of channels encoded in a frequency domain by using a time base to frequency base conversion. This audio decoder converts frequency domain to time domain. It expects data from an encoder that uses a sub-band filter or a Modified Discrete Cosine Transform (MDCT) encoding method. The U.S. Patent issued to Keyhl et al. (U.S. Pat. No. 5,926,553) discloses a method wherein input signals are also converted to the frequency domain, but as a stereophonic audio signal comparison test apparatus. PCT document number WO 96/12384 discloses similar features for processing stereophonic audio signals.

The U.S. Pat. No. 5,926,791 issued to Ogata et al. also discloses a sub-band encoding method. However, this method splits the frequency spectrum of an input signal into plural bands. The signals of each respective band are encoded and transmitted as serial output data. The encoding method includes a first step of splitting the input signal into a signal of a high frequency band and a signal of a low frequency band using a first stage low-pass filter and a first stage high-pass filter. Subsequent steps include encoding the signals of the respective frequency bands to generate a two-dimensional picture signal.

U.S. Pat. No. 5,960,390 issued to Ueno et al. discloses a coding method for using multi-channel audio signals to effectively prevent a pre-echo and a post-echo from being generated. This system is effectively a bunch of Discrete Fourier Transforms (DFT) or Discrete Cosine Transforms, (DCT) used with four banded filters and amplifiers which effectively creates frequency domain parameters that are recorded. Rather than using a Fourier transform, multiple DFT's affords selectivity and adaptability for dynamic wave component analysis. U.S. Pat. No. 5,974,379 issued to Hatanaka et al. discloses a signal encoding method having similar encoding features as described in U.S. Patent issued to Ueno et al. (5,960,390).

U.S. Pat. No. 6,032,113 issued to Graupe discloses a speech reconstruction method which provides a combination of vocoder-like reconstruction of speech from autoregressive (AR) parameters by keeping a reduced set of original speech samples. This system is an autoregressive linear predictive encoder that is combined with a set of signal samples. In effect this is a stochastic measure of autocovariance and autocorrelation which is a relative of the Fourier transform. The algorithms are convoluted and recursive and promises 2:1 compressability.

Foreign Patents granted to Fraunhofer (DE 4135977) and Johnston (EP 0 655 876) disclose signal processes of general relevance to the audio compression method herein described, which simultaneously transmit N-signal sources over a corresponding number of transmission channels.

None of the above inventions and patents, taken either singularly or in combination, is seen to describe the instant invention as claimed. Thus, an audio compression method and system solving the aforementioned problems is desired.

### SUMMARY OF THE INVENTION

A method and system for communicating audio signals at a low bit rate and yet retaining significant representation of the original signal is disclosed. This method interweaves both compressed audio and a messaging protocol into a data stream that can be transmitted over any digital communication medium, thereby eliminating the need for higher levels of protocol overhead. A digitally sampled wave (from a microphone) is accumulated in a memory and subsequently compressed by finding a maximum value (peak) followed by a minimum value (valley) and recording the count of the number of samples between the peak and valley. A digital band pass filter (BPF), such as an IIR or FIR, is used on the input raw wave to smooth and eliminate noise thus increasing compressibility. A protocol consisting of commands and information are interwoven with the compressed signal. This interwoven protocol data is de-commutated prior to regeneration of the signal. The output of the audio compressor and protocol commutator is connected to a transmission channel that provides a circuit path to the receiver. An audio wave is regenerated by connecting a half wave spline containing a point for each sample between a peak and valley. A cosine function is used to regenerate the spline. The regenerated signal is placed into a memory that subsequently transfers the signal to a digital- to-analog converter that is connected to an audio sensor (earphone or speaker).

Accordingly, it is a principal object of the invention to provide an audio compression method and system which interweaves both compressed audio and a messaging protocol into a data stream that can be transmitted over any digital communication medium at a low bit rate and yet retaining significant representation of the original signal.

It is another object of the invention to provide an audio compression method and system which achieves a low noise signal with a compression ratio of 8:1.

It is a further object of the invention to provide an audio compression method and system which produces an audio wave regenerated by connecting a half wave spline containing a point for each sample between a peak and valley of the original signal.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a high level block diagram of an audio compression method and system according to the present invention.

FIG. 2 is a block diagram of the compressor, which illustrates the component parts that reduce the half wave splines into 2 datums.

FIG. 3 is a block diagram of a commutator which illustrates the components that commutate messages with the compressed data.

FIG. 4 is a block diagram of a decommutator which illustrates the message separation features from the compressed data.

FIG. 5 is a block diagram of a decompressor which illustrates the components that recreate the spline half waves and inserts data when jitter is caused by delayed transmission and lost packets.

FIG. 6 is an actual audio sample after it has passed through a band pass filter −300 hz-3200 hz.

FIG. 7 is a simple first derivative of the audio sample that illustrates that the peaks occur at the sample where the sign of the derivative changes.

FIG. 8 is a comparison of the original audio sampled signal which is overlaid with the re-generated half wave splines.

FIG. 9 is a illustrative compressor data from an output stream of 7 bytes.

FIG. 10A is a partial listing of embedded messages according to the invention.

FIG. 10B is a second portion of the partial listing of embedded messages of FIG. 10A.

FIG. 10C is a final list portion of the partial listing of embedded messages of FIG. 10B, illustrating the audio compression method.

FIG. 11 is an conventional exemplary chip for encoding and decoding high resolution image or video data.

Similar reference characters denote corresponding features consistently throughout the attached drawings.

### DETAILED DESCRIPTION OF THE PREFERRED EMBODIMENTS

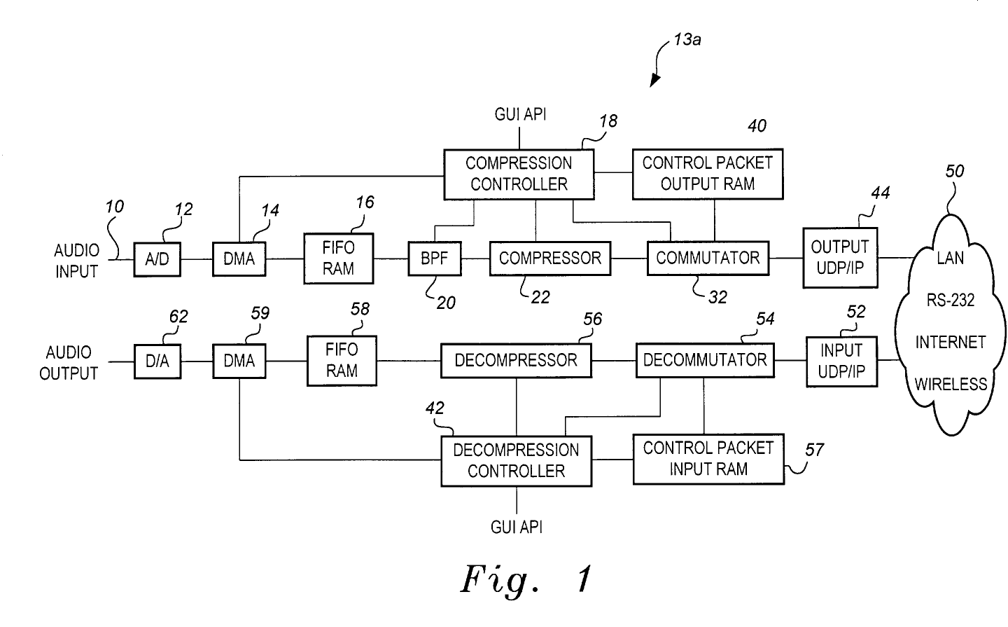

The present invention is directed to a method and system for improving the usability of transmission paths for wave signals such as speech, voice or audio data signals by compressing half waves as autonomous parts that can be transmitted from end to end in a timely fashion, resulting in significantly reducing the compression delays at each end. The preferred embodiments of the present invention are depicted in FIGS. 1-10B, and are generally referenced by numerals 13a and 13b, respectively. A conventional integrated circuit (IC) chip is shown in FIG. 11 as an exemplary means by which a large array of image or video data is compressed and subsequently displayed as an analogous means to perform the same utilizing an IC chip for-processing compressed audio data.

As further described hereinbelow, there are two preferred embodiments of the invention; an embedded real time software driver (ERTS) and a gate array (GA). The ERTS can be implemented on any computer that contains an audio and a communications interface. The Audio Compression Method (ACM) can be implemented into a large GA, and will simply incorporate the same functionality in the ERTS but in convoluted logic on silicon with memory mapped port addresses which would provide an interface exchange for parameters and messages, as diagrammatically illustrated in FIG. 1.

As shown therein, an analog audio signal 10 is input from a microphone to an analog to digital converter (ADC) 12. The ADC is sampled by a direct memory device (DMA) 14 which transfers each datum (8 bit byte, trimming low order bits if the ADC 12 samples more that 8 bits) to a first-in-first-out (FIFO) memory 16, location. The DMA 14 may be replaced by an interrupt driven driver which directly gets data from the ADC 12 and puts it into the FIFO memory 16. The sample rate is determined when the compression controller (CCTRL) 18, initializes the DMA 14. A band pass filter, (BPF) 20, gets datum from the FIFO memory 16, filters it using dynamically alterable band pass coefficients, and passes it's output to the compressor 22. Optionally, the CCTRL 18 may request the BPF 20 to provide both it's input and output data for recording if so directed from its application program interface (API). The BPF 20 is a finite impulse response (FIR), filter 20 which is balanced and does not introduce phase shifts into the datum. FIR filter coefficients are initialized on start-up and may be modified at any time by the CCTRL 18. As a result of its convolution, the output of the FIR filter 20 is delayed by the time equivalent to the number of samples equal to the number of coefficients. An alternate filter which does not requires many coefficients, is an infinite impulse response (IIR) filter, and may be selected by the compression controller 18 to reduce the end to end delay, however, IIR filters do introduces a phase shift in the datum. Output from the BPF 20 is input to the compressor (COM) 22.

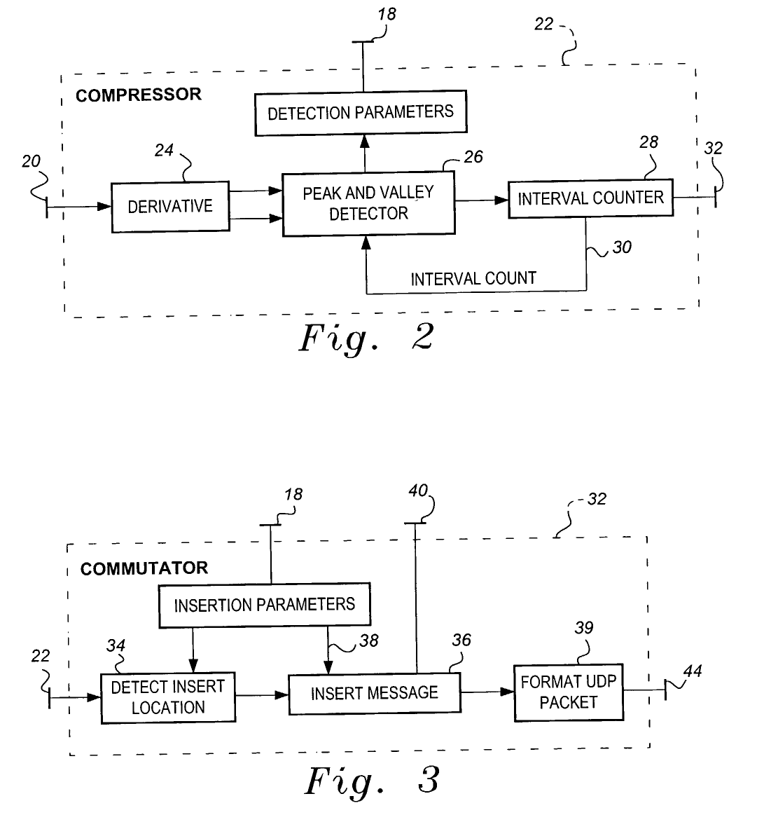

In the compressor 22, successive datum output from the BPF 20 are subtracted from the previous datum or derivative 24 illustrated in FIG. 2. This forms a second data stream, parallel to the digital audio data which is input by the peak and valley detector (PVD) 26. The PVD 26 is parameter driven by the CCTRL 18 and may be changed at anytime, including during real time operation of the system 13a. As a default, a peak and valley is detected every time the sign of the current derivative inverts and there have been at least 2 samples since the last inversion and the sign of the next derivative is the same as the current derivative. When a derivative is near zero and near mid range value, (128), parameters from the CCTRL 18, such as a range of 2 from mid range to help identify audio inactivity, and successive derivative inversions are ignored.

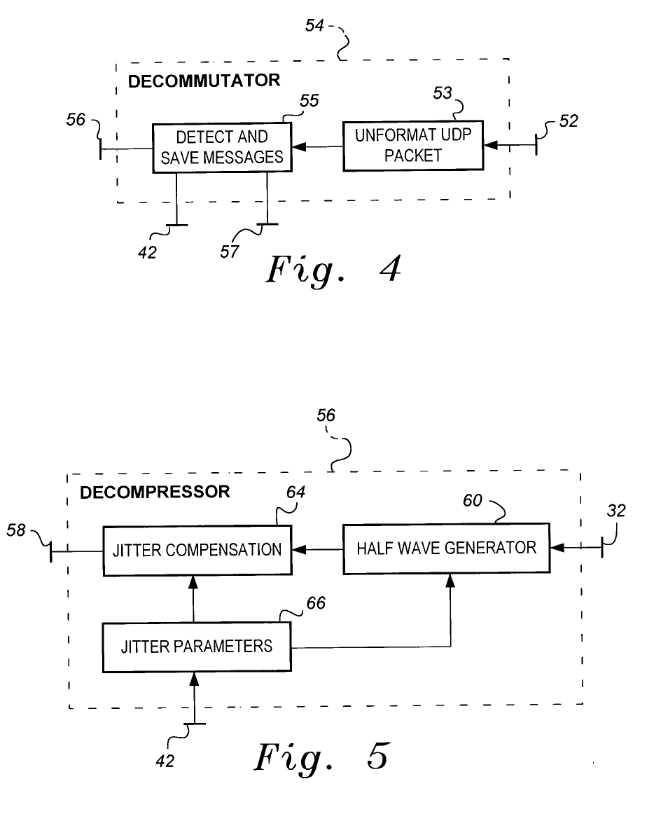

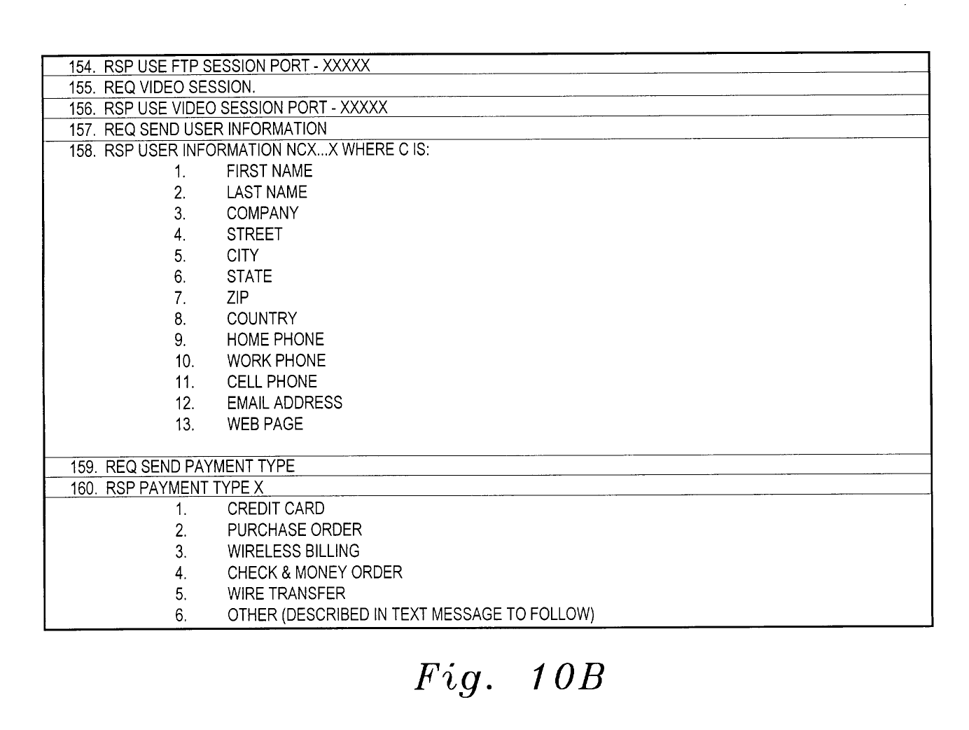

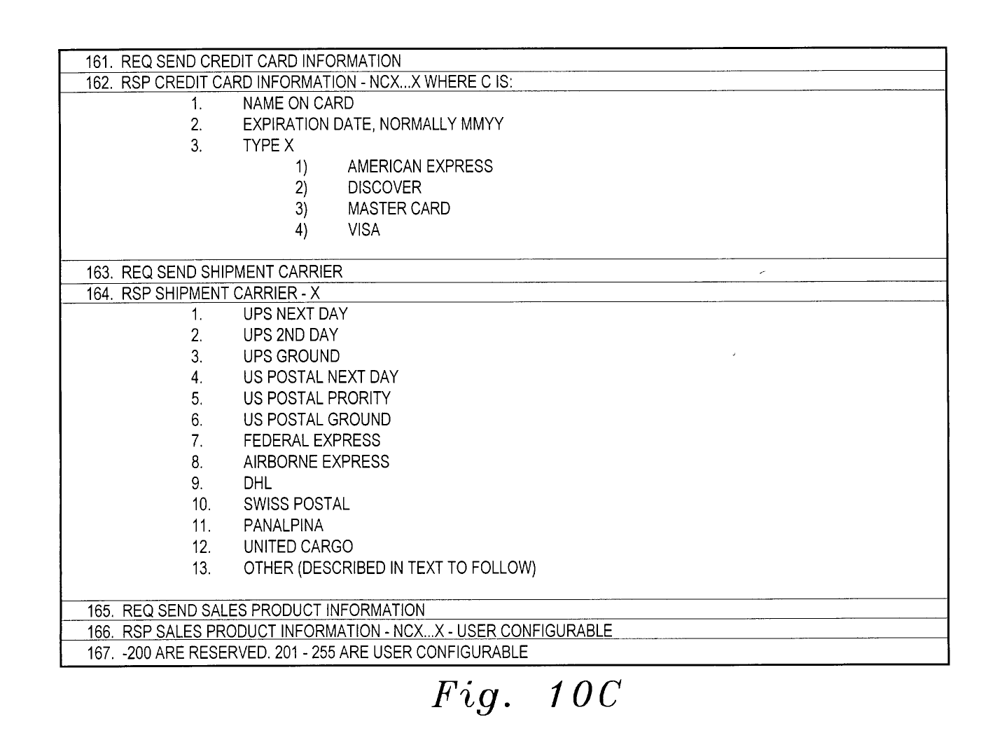

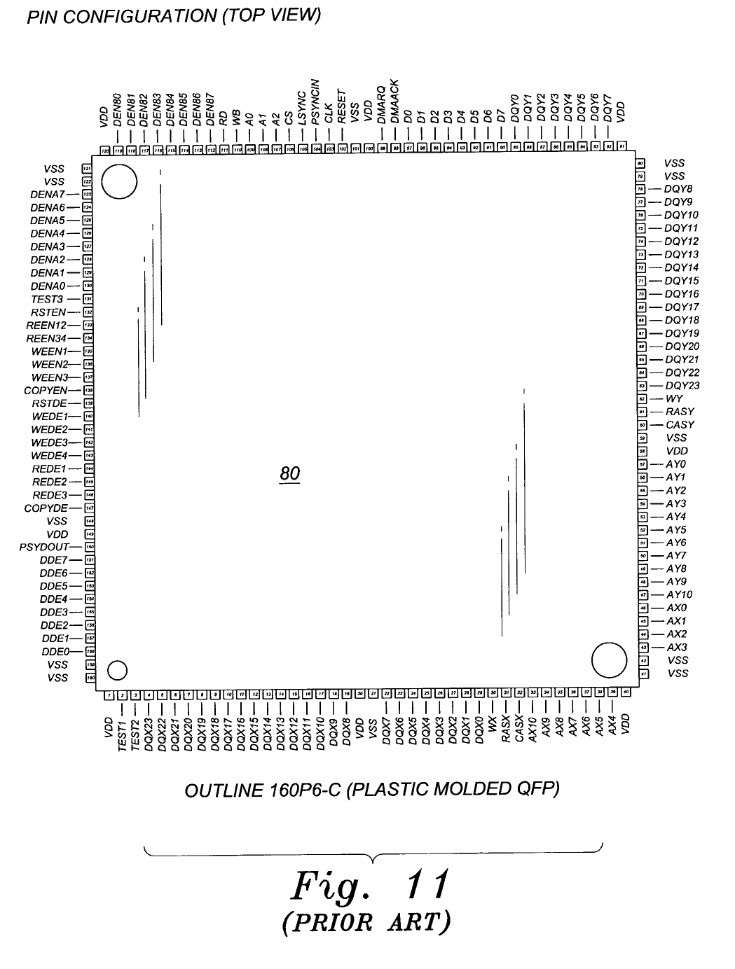

A peak and valley are tagged as Wave Measurements (WM). As the digitized audio data stream is passed from the PVD 26 to a interval counter (ICTR) 28 illustrated in FIG. 2, the ICTR 28 simply counts the samples between WM's. The interval count (IC) 30 is then fed back to the PVD 26 and is used to help select successive WM's. The maximum value of the IC 30 can reach 127 before a WM must be inserted to restart the IC 30. When a WM is detected, the IC 30 is reset to zero and the count is restarted. For example, in FIG. 6, there is shown sampled voice data output from the BPF 20. In FIGS. 6, 7 and 9, the compression process is illustrated on a small audio sample. The IC 30 for this sample is the number of samples between two adjacent WM's and does not include either WM. The output of the ICTR 28 is input to the commutator (CMUT) 32 illustrated in both FIGS. 1 and 3, which in turn inserts messages, such as those listed in FIGS. 10A-10C, into the compressed data stream. In detect insert location (DIL) 34 illustrated in FIG. 3, the current compressed data rate is instantaneously determined and made available to the CCTRL 18 and insert message (INMSG) functions 36.

The CCTRL 18 dynamically provides insertion parameters (INPARMS) 38, to DIL 34 and INMSG 36 which performs the timely insertion of messages into highly compressed parts of the data stream. According to FIG. 3, the INMSG 36 retrieves messages sequentially from the control packet message output RAM (MSGOUT) 40 illustrated in FIG. 1, which is a circular queue. When the MSGOUT 40 is empty, INMSG 36 may automatically insert un-requested and unsolicited administrative and maintenance messages governed by parameters available via the INPARMS 38 from the CCTRL 18. These parameters are normally static but may be altered via the CCTRL 18 application program interface (API). The data stream from the INMSG 36 is in a form that may be transmitted over a direct RS-232 interface via dedicated ports. However, normally, it is necessary to break up the data stream into small user datagram protocol (UDP) packets, within an Internet Protocol (IP). This task is accomplished by format UDP packet (FUP) 39 illustrated in FIG. 3, and the packet size is determined by parameters from both the CCTRL 18 and decompression controller (DCTRL) 42 illustrated in FIG. 1.

Output flow control is maintained by the FUP 39 function which determines that a backup has occurred by either a message from the client or by obvious observation of data back up. FUP 39 notifies INMSG 36, deletes inter speech gaps, and optionally deletes spline duplets. Administrative functions inserted by INMSG 36 are used by both the CCTRL 18 and DCTRL 42 to determine transmission metrics, which are then used to derive optimum packet size. Packet size, which is also based on the current bit rate, may vary significantly from packet to packet. The payload in a packet is preceded by an IP header, minimally five 32 bit words, and a UDP header which is minimally two 32 bit words. No IP header options are implemented, so the total overhead from packet headers is 28 bytes.

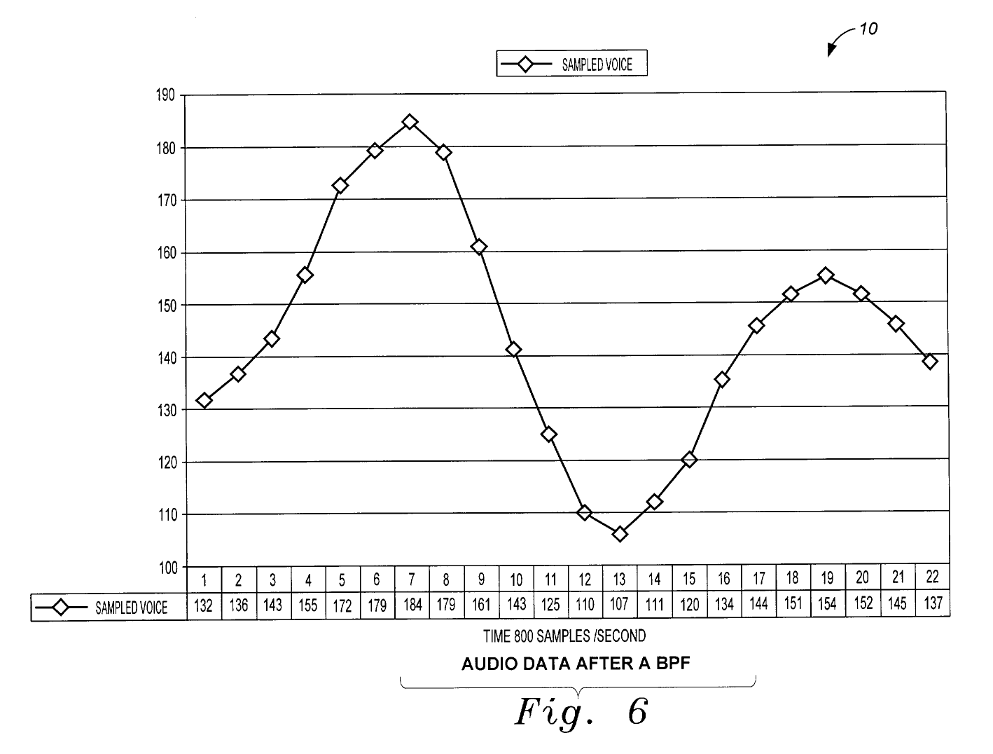

As diagrammatically illustrated in FIGS. 1, 4 and 5, packets are transmitted over a communications medium 50 (i.e. LAN, RS-232, Internet, Wireless) to a connected client 52 where they are buffered via an unformat UDP packet 53 as illustrated in FIG. 4. The packet is then separated into a compressed audio data stream and messages by the decommutator (DMUT), 54. When a synchronization byte, 0, is detected, the DMUT 54 will insert a WM value of 127 or a count of 1 into the data stream if the stream has somehow gotten out of sync. The DMUT 54 maintains data stream integrity for the decompressor (DCOM) 56 illustrated in both FIGS. 1 and 5, respectively. When messages listed in FIGS. 10A-1C, require action, the decompression controller (DCTRL) 42 performs the required task. The most critical task is a change in sample rate which requires the DCTRL 42 to modify the direct memory access transfer (DMA) rate 59 illustrated in FIG. 1, at the proper time.

In the DMUT 54, the detect and save messages (DMSG) function 55 maintains a sample count which was derived during the separation of the compressed audio data stream and messages and it is also provided to the DCTRL 42 with the sample rate change message in FIG. 10A, at least. This sample count is compared to the current sample count maintained by a half wave generator (HWG) 60 illustrated in FIG. 5 and the current depth of the number of samples in the first-in-first-out (FIFO) RAM 58 as illustrated in FIG. 1, to determine when to modify the DMA 59 and output signal generation rate to the D/A, 62. The HWG 60 executes a spline half wave function, Equation 1 (further described below), for each IC. This reconstruction approximation-of the original signal 10 is deposited into the output FIFO 58, by jitter compensation (JCOM), 64 illustrated in FIG. 5. The JCOM element 64 detects when DMA 59 under run has occurred as possibly a lost packet, and inserts mid values, 127 into the data stream until the under run has abated. The activity of JCOM 64 is determined by jitter parameters 66 as illustrated in FIG. 5, and provided by DCTRL 42 illustrated in FIG. 1. This is further defined within the commutated protocol.

Commutated Protocol

The input/output data streams are composed of 8 bit bytes. Alternate bytes are Wave Measurements (WM) that ranges in value from 1 to 255. Between two WM bytes is an Interval Count (IC), which ranges in value from 1 to 127. A Control Packet (CP) 57 is composed of a Control Command (CC) followed by zero or more Command Data (CD) bytes that may be inserted between the WM and IC. A CC ranges in value from 128 to 255.

CC REQ 129 requests is a synchronization from the client byte to be inserted into the clients incoming code. Other Control Packets send or request other information such as sample rate, the level of compression, and ASCII text.

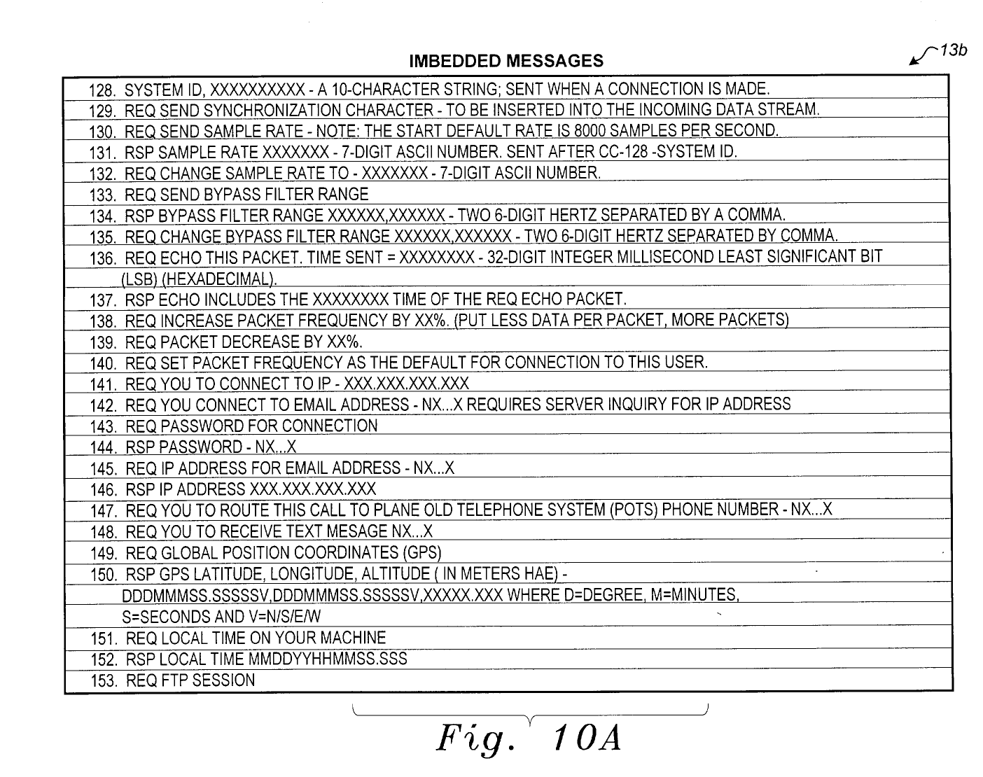

From FIG. 9: 132,5,184,129,5,107,5,154

Synchronization is performed by inserting a 0 anywhere prior to a WM.

From FIG. 9: 0,132,5,184,129,5,107,5,154

Peak and Valley Detection

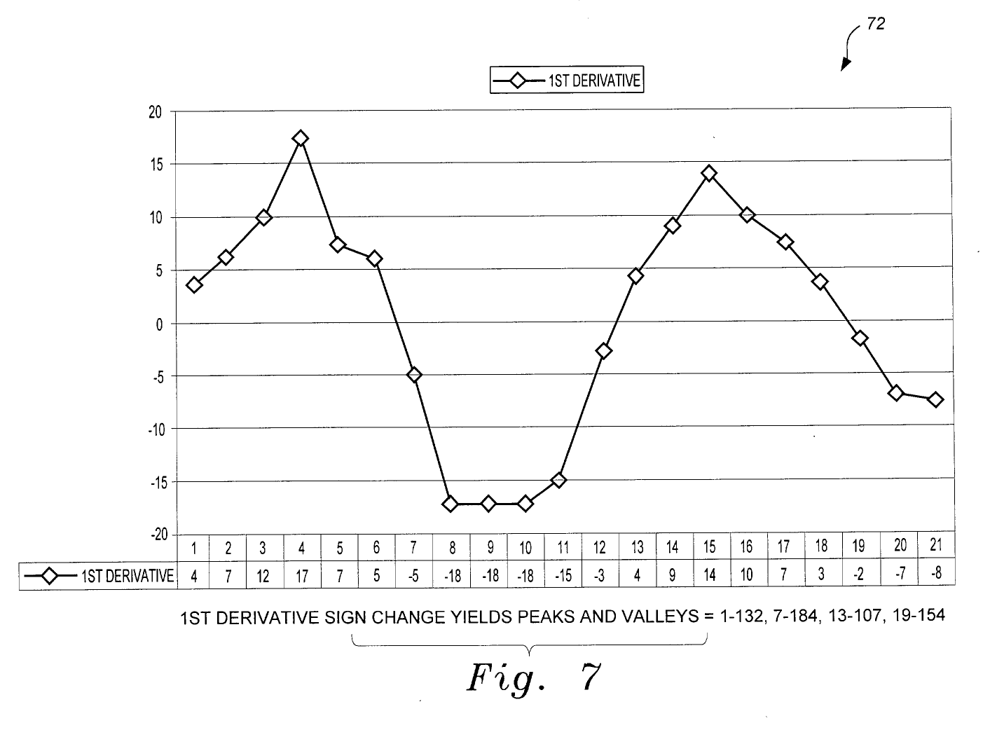

A peak and valley are digital samples that are selected using two or more look ahead samples to determine when the first derivative reaches zero. This particular feature is illustrated in FIG. 7 via curve 72, which describes first derivatives taken with respect to the sampled voice data 10 illustrated in FIG. 6. Derivative reversals within less than 3 samples may be ignored, and quiet is when the derivative oscillates within a predefined range such as two or less. For example, WMₜ=5 and IC=112 when the noise oscillates between 3 and 7 for 114 samples. Ignoring reversals and small ranges has many special effects such as the signal could drift for 113 samples and have a WMₜ₊₁=118.

Spline Generation

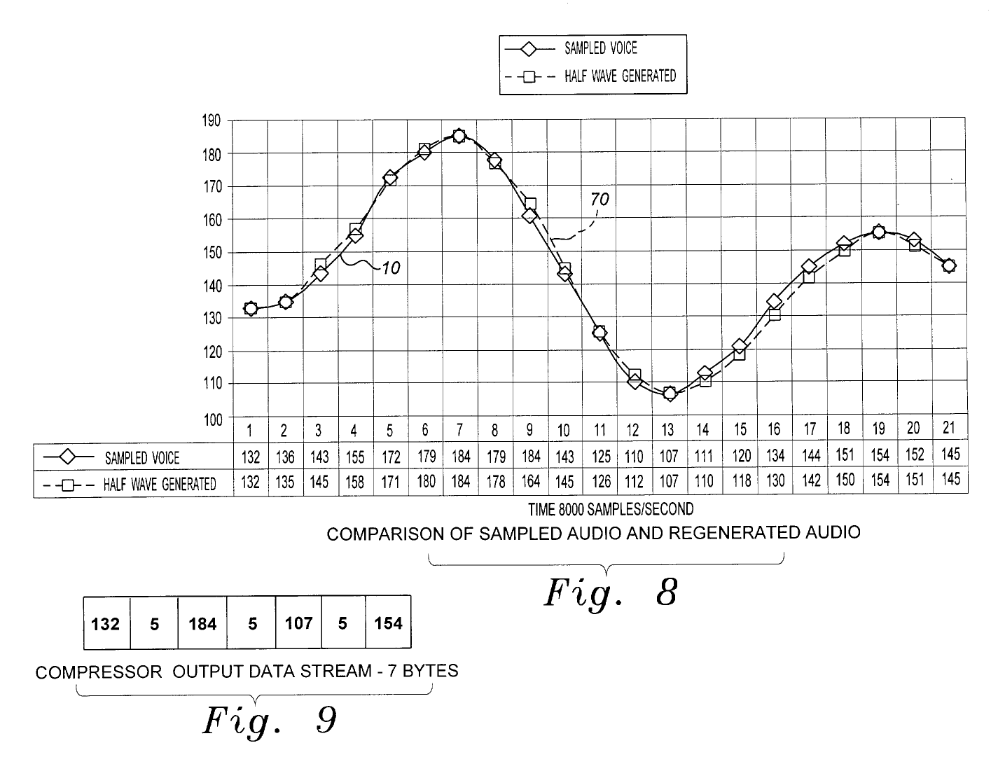

As diagrammatically illustrated in FIG. 8, a regenerated wave 70 as a spline fit to the original sampled voice wave 10. A spline is a curved line that is intended to match a desired shape. In the preferred case, a cosine function is used to create Audio Compression Method SPLINES. For a cosine function, the curve from 0° . . . 180° is used when WMₜ is greater than WMₜ₊₁ and the other half when less than. The points in between WM's are computed for each 180°/(IC+1) increment between the end points. The following general and Equation 1 explains how to GENERATE the Audio

Compression Method SPLINE Curve:

$$\begin{matrix}\begin{matrix}Spline Generation Function \\ INT ( ( ( ( {WM}_{t + 1} + {WM}_{t} ) ) - ( ( {WM}_{t + 1} - {WM}_{t} ) ) *\end{matrix} \\ COS ( ( 180 / ( IC + 1 ) ) * i * PI ( ) / 180 ) ) / 2 ) \vert i = 1 … IC\end{matrix} \qquad Equation 1$$

Both WMₜ and WMₜ₊₁ have absolute values, so the equation is solved for sample points, 1 . . . IC, between two WM's.

Audio Compression Method Implementations

There are Two Primary Types of Implementations of the AUDIO

Compression Method:

1. A real-time computer program with Application Program Interfaces (API's) to an extended operating system service driver

2. A Gate Array with an API accessed driver.

Control Commands

The Control Commands are either unsolicited or solicited. Unsolicited commands may be sent without a request. Solicited commands require a request and response. Some requests require several responses. All messages are ASCII text. Variable length messages, X . . . X, are preceded by a binary number of characters in the message byte, N, which can never have a value of zero. Sub-messages are preceded by an index number, C, which can never have a value of zero and it is included in the number of messaged bytes, N.

Other advantageous features included wherein,

*Audio<3000 Hz

1. Small compression fragments offers minimum delay and natural speech real time response

2. High compression quality

3. Overall compression ratio average of greater than 8 to 1.

4. Less than 3000 bps (bits per second) during words −580 bps between words

5. Variable sample rate

6. Conference large groups

7. Lecture large numbers through low bandwidth with common participation

Music

1. High sample rates provide high compression and higher quality

2. User controlled compression allows up to 1000 songs on one CD

Commutated Commands

1. Text Messaging,

2. Identification and User Information Transferal,

3. Embedded commands for ancillary connections such as File Transfer and Video,

4. Request Synchronization,

5. Global Positioning System Coordinates,

6. Select very low bit rate LISTEN mode,

7. Vary sampling rate dynamically to control quality,

8. Vary filter bandwidth to control quality,

9. Embedded Transaction processing, and

10. User configurable commands,

Further advantages include wherein, waveforms are separated into half waves. The start and end of each half wave (peak and valley) are selected. The number of samples between the start and end of the half wave are counted. Note however, that the end of one wave is the start of the next half wave. So, the start voltage value of a half wave (peak or valley) and the number of samples before the end of a half wave, compose two eight bit digital numbers that represent the half wave. After transmission to a receiver that contains the decompression apparatus, a half wave very similar to the original is regenerated by connecting a spline between the start and end that contains a synthesized sample for each of the original samples between the start and end of the half wave.

The number of points on the spline between the start and end of the regenerated half wave is equal to the count of the number of samples between the original signal half wave start and end. These points on the spline are regenerated by a cosine function that uses the start and end points as the peak and valley (or vice versa) of a half wave. All of these features can be incorporated in a single Integrated Circuit (IC) chip. As diagrammatically illustrated in FIG. 11, a conventional IC chip 80 for compressing video data is shown by way of analogy for compressing audio data signals. The IC chip 80 is a M65790FP chip made by MITSUBISHI for compressing and decompressing image data according to Fixed Block Length Truncation Coding (FBTC). Some of the features of then IC chip 80 include low data distortion, easy decision for data memory capacity by constant compression, encoding, decoding and image data editing with high speed data processing at a rate of 20 MBps, including a built in 16 Mbits DRAM controller, etc.

By way of analogy, the compression method and system as herein described replace the need for higher levels of real time control protocol. When there is a delay in the network and the generated audio requires a gap . . . then the generation software repairs that gap based on the length of the gap in an active voice. A parameter determines the width of ignored gaps during voice. Another parameter determines how much of the inter-word space to remove when a gap has occurred. Accordingly, this compression method and system facilitates VoP (Voice over Packet) and TDMoP (Time Division Multiplex over Packet) voice communication where QoS (Quality of Service) is paramount.

The required functions for a TDM-to-IP system falls into two basic areas: voice processing and packetization. For voice processing the functions that need to be implemented include echo cancellation, compression, voice activity detection, CNG, silence suppression and DEMF/tone detect/fax relay. Packetization, normally requires RTP/RTCP processing, payload construction, jitter buffer, ATM AAL1 AAL2 or AAL5 and IP-UDP Ethernet. A prime consideration when developing an interface to the packet domain is how to maintain a high level of voice quality while also achieving a cost-effective implementation. However, this patent claims to include an embedded form of real time protocol that provides for jitter compensation and QoS functions. The primary embodiment of the invention is an embedded real-time driver in a computer system that has audio and communication interfaces. Another embodiment of the invention is a Field Programmable Gate Array or ASIC which is commonly referred to as a CODEC system chip (coder-decoder).

It is to be understood that the present invention is not limited to the embodiments described above, but encompasses any and all embodiments within the scope of the following claims.

I claim:

1. An audio compression method for transmitting lossey real-time audio signals over a communication network, comprising the steps of:
(a) sampling at least one audio signal,
(b) converting said at least one audio signal,
(c) storing said converted signals of step (b) in at least one register as a random access memory location,
(d) filtering said stored data signals from said at least one register of step (c),
(e) compressing said filtered data signals wherein said compression step further includes the steps of:
(e1) determining a first derivative of said filtered data signal, and regenerating compressed data signals,
(e2) detecting at least one local peak and valley of the filtered data signal over a specified interval,
(e3) transmitting the detected data as detection parameters
(e4) initiating an interval counter, and
(e5) transmitting an interval count as feedback data to step (e2), and
(f) formatting said detection parameters into a control packet.

2. The audio compression method, according to claim 1, further comprising the steps of:
(g) inserting the packet of detection parameters in steps (h) and (i),
(h) detecting an insert location,
(i) inserting message data of predetermined size, and
(j) outputting the compressed signals and message data to at least one client via a communication network.

3. The audio compression method, according to claim 2, further comprising the steps of:
(k) unformatting the audio data of the outputting step (j),
(l) detecting the unformatted audio data,
(m) generating a half wave fit for the detected audio data,
(n) generating jitter parameters,
(o) compensating said data of step (m) for jitter,
(p) storing said compensated audio data signals, and
(q) outputting the audio data signals via a speakerphone.

4. The audio compression method, according to claim 1, wherein said determining step (e1) further comprises the step of applying a spline fit to regenerate the data signals according to the equation:
INT((((WMₜ₊₁+WMₜ))−((WMₜ₊₁−WMₜ))*COS((180/(IC+1))*i*PI( )/180))/2)¦ where i=1 . . . interval count (IC).

5. The audio compression method, according to claim 1, wherein said sampling step (a): include sampling at least one analog audio signal.

6. The audio compression method, according to claim 5, wherein said converting step (b): includes converting at least one analog signal to a corresponding digital audio signal.

7. The audio compression method, according to claim 1, wherein said sampling step (a): include sampling at least one digital audio signal.

8. The audio compression method, according to claim 7, wherein said converting step (b): includes converting said at least one digital audio signal to a corresponding analog audio signal.

9. The audio compression method, according to claim 7, wherein said converting step (b): includes converting said at least one digital audio signal to a corresponding analog audio signal.

10. An audio compression system for transmitting voice data over a communication network, comprising:
an audio microphone for detecting at least one analog voice signal in a computer; said computer includes a first converter for converting analog signals to digital signals, and a compression controller for controlling and selectively packeting said at least one analog voice signal as digital output;
a decompressing controller for decompressing said digital output and storing said digital output; and
a second converter for converting said digital output to a corresponding analog out put signal.
